(19) United States
(12) Patent Application Publication
(10) Pub. No.: US 2015/0086152 A1
(43) Pub. Date: Mar. 26, 2015

(54) QUASIOPTICAL WAVEGUIDES AND SYSTEMS

(71) Applicant: Halliburton Energy Services, Inc., Houston, TX (US)

(72) Inventors: Etienne Samson, Cypres, TX (US); John Maida, Houston, TX (US); David Andrew Barfoot, Houston, TX (US)

(21) Appl. No.: 14/490,335

(22) Filed: Sep. 18, 2014

Related U.S. Application Data
(60) Provisional application No. 61/880,426, filed on Sep. 20, 2013.

(51) Int. Cl. G02F 1/29

(52) U.S. Cl. CPC G02F 1/29
USPC 385/8

(57) ABSTRACT

Various embodiments include systems and methods to communicate along pipes using a conductive waveguide at quasioptical frequencies. The communication can be conducted as propagation to and from a tool at the quasioptical frequencies. A communication architecture may include a transmitter and receiver at one end of the conductive waveguide and a modulation device at an opposite end of the conductive waveguide. Additional systems and methods are disclosed.

### RELATED APPLICATION

This application claims the priority benefit of U.S. Provisional Application No. 61/880,426, filed Sep. 20, 2013 which is incorporated herein by reference in its entirety.

### TECHNICAL FIELD

The present invention relates generally to apparatus, systems, and methods related to oil and gas exploration.

### BACKGROUND

In drilling wells for oil and gas exploration, understanding the structure and properties of the associated geological formation provides information to aid such exploration. Measurements in a wellbore, also referred to as a borehole, are typically performed to attain this understanding. However, the environment in which the drilling tools operate is at significant distances below the surface and measurements to manage operation of such equipment are made at these locations. In addition, it is important to monitor the physical conditions inside the borehole of the oil well, in order to ensure proper operation of the well. In turn, the data collected via monitoring and measurement is transmitted to the surface for analysis and control purposes.

Electrical cables have been investigated for high speed communications to and from downhole tools. However, use of electrical cables for such communication has drawbacks due to limitations with information bandwidth of electrical cables. Optical fibers have been investigated for high speed communications to and from downhole tools to overcome the information bandwidth limitations of electrical cables. For real-time communications of downhole measurements while drilling, there has been no realistic electrical cable solution, to date, due primarily to the fact that electrically insulated connectors must be employed for low signal loss. Also, there has been no realistic optical fiber cable solution, to date, due primarily to the fact that near perfect optical alignment must be employed for low signal loss. There is ongoing effort to develop systems and methods that can allow for more flexibility without significant loss of precision in relatively high speed communication from and to tools located downhole at a drilling site.

### BRIEF DESCRIPTION OF THE DRAWINGS

FIG. 1 shows an example waveguide that can be used in downhole communications, in accordance with various embodiments.

FIG. 2 shows an example of another form of a waveguide that can be implemented for operation downhole in a wellbore, in accordance with various embodiments.

FIG. 3 shows a test apparatus that demonstrates waveguide transmission using terahertz wave radiation, in accordance with various embodiments.

FIGS. 4A and 4B show a typical terahertz pulse and Fourier transform of a quasioptical bandwidth, in accordance with various embodiments.

FIG. 5 shows a block diagram representation of an example system operable to transmit and receive quasioptical signals in a wellbore, in accordance with various embodiments.

FIG. 6 shows a block diagram representation of an example system operable to transmit and receive quasioptical signals in a wellbore, in accordance with various embodiments.

FIG. 7A shows an example of a drill pipe having a waveguide disposed within it, in accordance with various embodiments.

FIG. 7B shows an example of a number of drill pipes connected together, where each drill pipe has a waveguide disposed within it, as represented in FIG. 7A, in accordance with various embodiments.

FIG. 8 shows an example of a drill pipe having a waveguide disposed outside the drill pipe, in accordance with various embodiments.

FIG. 9 shows features of an example method of communicating using quasioptical waves, in accordance with various embodiments.

### DETAILED DESCRIPTION

The following detailed description refers to the accompanying drawings that show, by way of illustration and not limitation, various embodiments in which the invention may be practiced. These embodiments are described in sufficient detail to enable those skilled in the art to practice these and other embodiments. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

In various embodiments, quasioptical electromagnetic (EM) wave energies can be used in methods for high speed command and data communication along pipelines. Such methods can be used for communications to and/or from downhole tools in a wellbore including downhole telemetry, while drilling, logging, or drilling and logging, and for terrestrial and aerial applications along pipelines and power lines. Logging includes wireline, slickline, and coiled tubing logging, among other types. These methods can provide capabilities not currently available in existing “cabled” forms of electromagnetic communications, such as electrical coaxial cables, twisted-pair cables, and optical fiber cables. Quasioptical EM wave energies are herein defined as EM wave energies of frequencies from 30 GHz to 10 THz. This frequency range includes EM frequency bands typically called millimeter waves (30 GHz to 300 GHz) and terahertz waves (100 GHz to 10 THz).

Very long millimeter and sub-millimeter EM radiation can be literally “piped” through long lengths of pipe forming a waveguide. In a wellbore for instance, the waveguide can be constructed in sections of jointed drill pipe lengths. Measurable zero-loss interconnect, or substantially zero-loss, connected (segmented) waveguide conduits may be used at standard drill pipe lengths, such as 30 or 40 ft. In addition, use of quasioptical waves can provide for a focused or highly directional signal in and out of structures arranged to propagate the quasioptical waves.

Quasioptical EM energy can be carried by waveguides without use of conventional electrical coaxial, twisted-pair conductors, or smaller optical fibers. Such waveguides can be structured as relatively large conduits, which can be hollow or filled. The waveguides can be dielectrically lined or plugged. Each jointed quasioptical waveguide can have electrically conductive and/or non-electrically conductive connectors at every pipe joint. Such segmented waveguides and connections can be arranged to operate as waveguides via low-loss total-internal reflection, similar to optical fibers, rather than a traditional electrical transmission line circuit. Also, with quasioptical wavelengths being approximately a thousand times larger than conventional near-infrared optical telecommunications wavelengths, precision physical connector alignment is not as difficult an issue as with the conventional near-infrared wavelengths.

The quasioptical waveguide can be realized in a number of different ways as a tube with an arbitrary cross section that is substantially uniform along a length of the tube. The quasioptical waveguide can be realized as a highly conductive metal to support quasioptical radiation propagation in various transverse electric (TE) or transverse magnetic (TM) waveguide modes of propagation. The quasioptical waveguide can be structured to provide single mode or multimode propagation. The conductive metal tube can be provided as copper pipes/tubes, steel tubes, inner lined steel, or other conductive metal tubes. As noted, tubes are not limited to circular cross sections, but may include square, rectangular, elliptical, or other cross sections. The conductive metal tube can be structured as a hollow tube or a dielectrically lined or filled tube, where the dielectric can be provided by vacuum, gas, liquid, or solid. For example, nitrogen gas can be used to fill a conductive metal tube. Other gases can be used that do not absorb the quasioptical radiation. The solid fill material may be a polymer or other structure that does not have a vibrational absorption band at the quasioptical frequencies used.

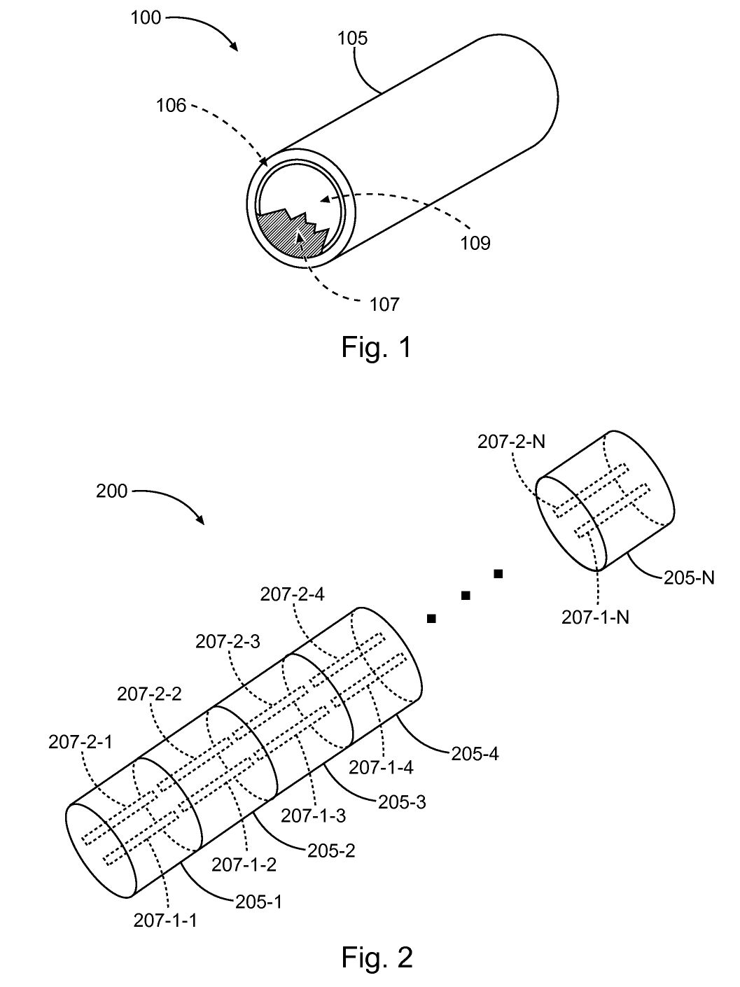

FIG. 1 shows an embodiment of an example waveguide 100 that can be used in downhole communications. The waveguide 100 can include a metal tube 105 with a conductive metal layer 107 on the inside surface of metal tube 105 and a dielectric layer 109 covering the conductive metal layer 107. Metal tube 105 can have an inner diameter that is large relative to an optical fiber but small relative to pipes used in drilling operations. The conductive metal layer 107 can be used to provide a highly conductive layer that can be relatively thin, such as, but not limited to, ranging from 1 μm to 20 μm, or about 2 μm to 10 μm, or about 3 to 8 μm. In one embodiment, the conductive layer may be 5 μm thick layer of copper or other highly conductive material. The dielectric layer 109 can provide a protective covering to the conductive metal layer 107. The dielectric layer 109 can be a small layer of a polymer, such as, but not limited to, polyethylene. The dielectric layer 109 may range in thickness from 50 μm to 500 μm, or about 100 μm to 250 μm, or about 150 to 200 μm. In one embodiment, the dielectric layer 109 may be 180 μm thick.

The inside diameter (ID) of the waveguide 100 can be round or rectangular (or square) or polygonal in geometric shape with effective TE and TM modal volume cross-sectional areas being similar. In FIG. 1, the inside diameter is shown as round, though as noted, other geometrical shapes can be used. The typical dimensions can be provided for a waveguide having a vacuum inner region or a gas-filled inner region. However, the conducting waveguide 100 may be filled with a solid dielectric, which will alter vacuum/gas dimensions accordingly.

For a circular waveguide, the cutoff wavelength for ideal single mode-only propagation can be given by 1.77r, where r is the inner radius in meters. For example, for circular gas-filled waveguides operating over the quasioptical EM band from 30 GHz (10,000 μm) to 10 THz (30 μm), the inner radius of a perfectly conducting tube can range from about 10,000 μm/1.77 to 30 μm/1.77, which is an inner radii from about 5.6 mm (11.3 mm diameter) down to about 17 μm (34 μm diameter). From these approximations, inside diameters can range from about 34 μm to as large as about 11 or 12 mm.

Internal dimensions will differ if the internal dielectric is a solid non-conductor, for example Teflon or other polymer, or if an inner thin dielectric coating is employed as shown by dielectric layer 109 in FIG. 1. Partial inner dielectric layers/coatings may be a small fraction of the overall inner diameter, which may be in the range of, but not limited to, 0.5% to 5% of the thickness of the inner diameter of the waveguide 100.

The waveguide 100 can have an outside diameter set to the inside diameter summed with twice the sum of wall thicknesses. An example of a range of outside diameters can include, but is not limited to, about 0.1 inches to about 0.6 inches.

The metal tube 105 may be structured from a material that can maintain its shape in harsh environments such as in wellbores. For example, the metal tube 105 can be, but is not limited to, a steel tube. The metal tube 105 can be selected of material of sufficient strength not be crushed during drilling operations. For mechanical crush resistance during installation and for good lifetime, the wall thickness of the outermost protective hydrostatic pressure barrier, such as but not limited to a stainless steel or incoloy sheath layer, may typically be about 0.049″ thick, but can be 0.5 to 2× this typical thickness for good safe crush resistance.

Though examples are provided for relative sizes of waveguide 100, it is clear that other dimensions and materials can be used. The dimensions can be selected based on the desired electromagnetic mode to be propagated in waveguide 100.

FIG. 2 shows an embodiment of an example of another form of a waveguide 200 that can be implemented for operation downhole in a wellbore. Waveguide 200 can include a number of tubes 205-1, 205-2, 205-3, 205-4 . . . 205-N connected together with each tube having a parallel plate waveguide disposed within it. Plate 207-1-1 and plate 207-2-1 are structured as parallel plates in tube 205-1. Plate 207-1-2 and plate 207-2-2 are structured as parallel plates in tube 205-2. Plate 207-1-3 and plate 207-2-3 are structured as parallel plates in tube 205-3. Plate 207-1-4 and plate 207-2-4 are structured as parallel plates in tube 205-4. Plate 207-1-N and plate 207-2-N are structured as parallel plates in tube 205-N. Connecting the set of tubes together in a serial construction can be accomplished with adjacent plates 207-1-(i) and 207-1-(i+1) coupled together and adjacent plates 207-2-(i) and 207-2-(i+1) coupled together for i=1, 2 . . . N. The two plates may include flex board plates with conductive traces thereon such that the conductive traces are parallel to each other. The flex board plates may be arranged as traces on curled or curved polyimide, where the widths of the traces of the two plates together, across the cross section of the respective tube, may be substantially equivalent to the circumference of the inner diameter of the respective tube. The tubes 205-1, 205-2, 205-3, 205-4 . . . 205-N may be structured as steel tubes. As a non-limiting example, the tubes 205-1, 205-2, 205-3, 205-4 . . . 205-N may be structured similar to a conventional ¼″ steel control line used in drilling operations.

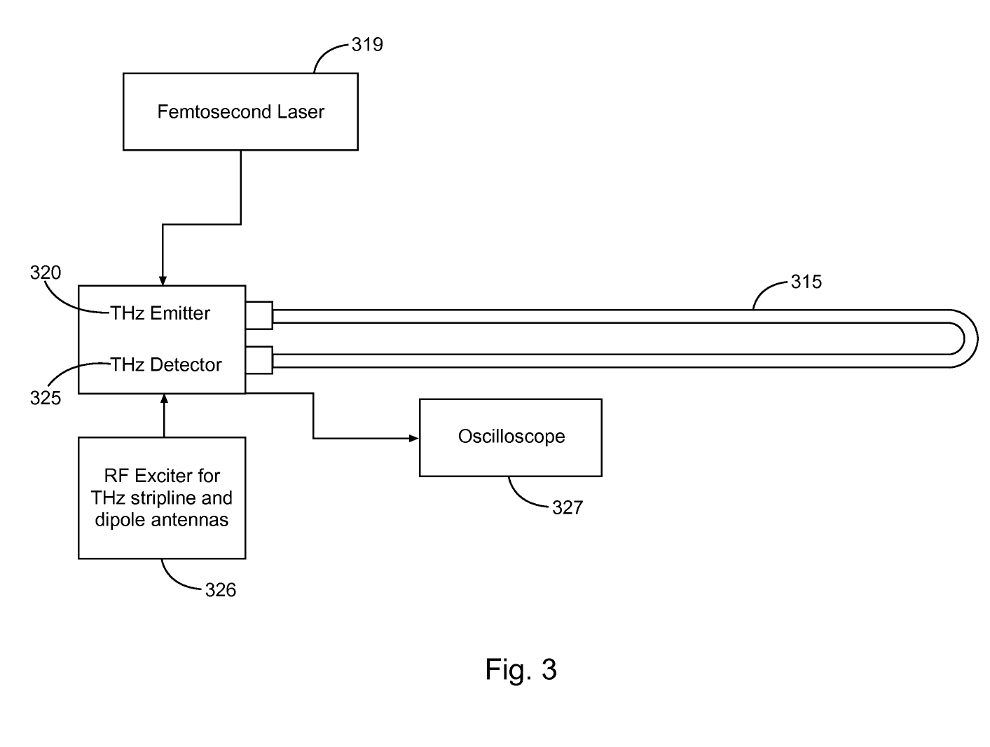

FIG. 3 shows a test apparatus 300 that demonstrates waveguide transmission using THz wave radiation. An experiment was conducted with test apparatus 300 that demonstrated that THz wave radiation can be coupled into ordinary jointed copper tubing and be made to propagate along about 100 ft. without detectable coupled power loss. A femtosecond 1560 nm laser driven THz Spectrometer (Menlo Systems/Batop Model K15) was modified for use as a continuous wave (CW) source of THz wave radiation with a peak THz wavelength of about 1 mm (300 GHz). The femtosecond laser 319 with peak laser wavelength of 1560 nm provided a pulse-width of approximately 100 fs with a 100 MHz repetition rate and 1450 nm to 1610 nm bandwidth. Various small copper pipes ranging in diameter from about ¼″ to ½″ were connected in a transmissive loop configuration 315 between the THz emitter 320 and a detector 325. A RF Exciter for THz stripline and dipole antennas 326 and an oscilloscope 327 were used in the measurement of received power. Relative received power levels were measured in an attempt to measure transmission loss. The received power between the THz emitter 320 butted to the detector 325 was measured as non-saturated reference power. The received power with the long copper piping of the transmissive loop configuration 315 inserted in between the THz emitter 320 and the detector 325 was measured. There was no appreciable measurable THz power loss detected during the initial investigation leading to the conclusion that low loss THz transmission can be attained with conductive tubes. It is noted that U.S. Pat. No. 8,259,022 along with proven electromagnetic waveguide theory shows that a low loss THz transmission may be less than about 1 dB/km using air-filled parallel-plate waveguides between a transmitting end and a receiving end.

Research performed in the 1970s by Bell Laboratories provides a demonstration of electromagnetic wave transmission in the frequency band from 40 GHz to 110 GHz using TE₀₁ waveguide mode. In this demonstration, a bit stream of 274 Mbit/sec was transmitted along a distance of 25 miles using a copper tube waveguide similar to the test apparatus of FIG. 3. Attenuation in the waveguide was measured to average approximately 0.6 dB/km with an 80 GHz wave frequency. Theoretical modeling shows that the attenuation should continue to decrease at higher frequencies for an ideal copper waveguide with a dielectric coating. This research confirms theoretical calculations presented in Microwave Engineering (by David M. Pozar) for circular copper waveguides, which showed that the attenuation of the TE₀₁ decreases as wave frequency increases above 10 GHz. Additionally, it is known that all TE_{0X} modes show monotonically decreasing attenuation with frequency for millimeter waves. Therefore, primarily exciting these modes, when transmitting into a circular waveguide, can provide for low attenuation in a millimeter wave transmission system and can reduce power transfer into other higher loss modes. In addition, although the TE modes are thought to be the lowest loss modes for transmission of millimeter waves in a circular waveguide, there is evidence presented in “Experimental verification of low-loss TM modes in dielectric-lined waveguide” (By J. W. CARLIN and A. MAIONE; The Bell System Technical Journal, Vol. 52, No. 4, April, 1973) that a properly designed waveguide can transmit TM modes with attenuation as low as 3.5 dB/km at 110 GHz, and perhaps lower attenuation at higher frequencies.

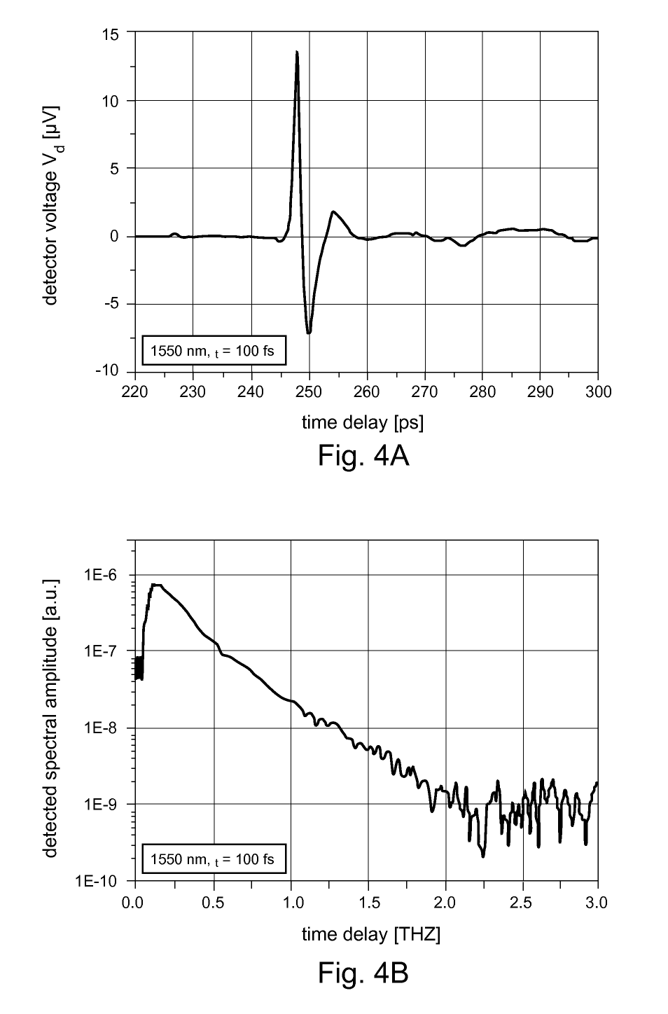

In various embodiments, a system can be structured to transmit and receive quasioptical signals. The system can include a transmitter operable to generate electromagnetic radiation in the frequency range from 30 GHz to 10 THz; a waveguide operatively coupled to the transmitter to propagate the electromagnetic radiation generated from the transmitter; a modulator disposed to receive the electromagnetic radiation from the waveguide, to modulate the electromagnetic radiation received from the waveguide, and to direct the modulated electromagnetic radiation back through the waveguide; and a detector operatively coupled to the waveguide to receive the modulated electromagnetic radiation. The waveguide can be structured as waveguide segments. The waveguide can have a cross section structure to excite only TE₀₁ propagation to the modulator. Alternatively, the waveguide can have a cross section structure to provide multi-mode propagation to the modulator. The system can be structured for high speed command and data communication in a wellbore or for terrestrial and aerial applications along pipelines and power lines. Techniques for generation and detection of quasioptical radiation for spectroscopy and imaging applications can be used for transmitters and detectors in systems taught herein. FIGS. 4A and 4B showed a typical THz pulse and Fourier transform of a quasioptical bandwidth.

The modulator to receive the quasioptical wave from the waveguide may be realized as a quasioptical wave modulator to modulate the quasioptical wave by deformable mirrors, choppers, electro-optic, or magneto-optic mechanisms. It is also anticipated that a CW quasioptical carrier wave can be generated, launched into the quasioptical waveguide, and transmitted to the modulator, where the modulator impresses information directly onto the CW quasioptical carrier wave. Quasioptical wave modulators suitable for high-speed telemetry have been fabricated and demonstrated in a laboratory setting. It is anticipated that quasioptical wave components, such as modulators, power splitters, filters, switches, etc., can be developed to impress and manipulate digital and/or analog information onto/off the quasioptical carrier of systems similar to or identical to systems discussed herein. Examples of efficient, high-speed quasioptical wave modulators can be found in “Broadband Terahertz Modulation based on Reconfigurable Metallic Slits” in photonics society winter topical meeting series 2010 IEEE, and “A spatial light modulator for terahertz beams” in Applied Physics Letters 94, 213511 (2009). The electromagnetic radiation from the transmitter may also be modulated by the same modulation method as employed at the end of the waveguide. For example, a transmitter and quasioptical wave modulator combination may be realized by modulating an excitation source or by external deformable mirrors, choppers, electro-optic, or magneto-optic mechanism modulating output from the transmitter prior to injection into the waveguide.

For frequencies below 1 THz, systems and methods, as taught herein, may be provided as low cost embodiments that may be implemented through the use of extremely high frequency semiconductor sources, modulators, and receivers conventionally designed for use with millimeter wave systems such as radar, wireless communication, etc. Sources are available for operating in frequency ranges up to 300 GHz, including silicon impact ionization avalanche transit-time (IMPATT) diodes and gun diodes as described in Microwave Engineering, pages 609-612, by David M. Pozar and in Advanced Microwave and Millimeter Wave Technologies Semiconductor Devices Circuits and Systems,” (March 2010) edited by Moumita Mukherjee. Systems disclosed herein can include combinations and/or permutations of different components disclosed herein.

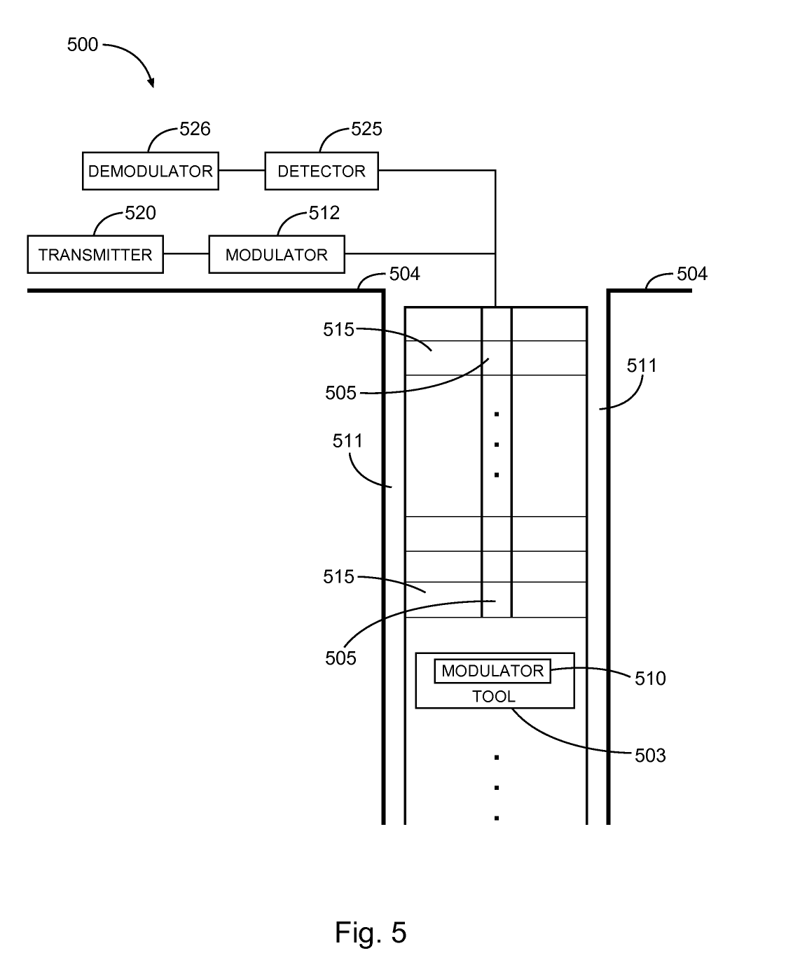

FIG. 5 shows an embodiment of an example system 500 operable to transmit and receive quasioptical signals in a wellbore 511. The system 500 can include a transmitter 520 operable to generate electromagnetic radiation in the frequency range from 30 GHz to 10 THz; a waveguide 505 operatively coupled to the transmitter 520 to propagate the electromagnetic radiation generated from the transmitter 520; a modulator 510 disposed to receive the electromagnetic radiation from the waveguide 505, to modulate the electromagnetic radiation received from the waveguide 505, and to direct the modulated electromagnetic radiation back through the waveguide 505; and a detector 525 operatively coupled to the waveguide 505 to receive the modulated electromagnetic radiation. The waveguide 505 can be structured as waveguide segments. This system architecture provides for a single-ended (reflective) waveguide configuration for transmission back to surface 504, where it can be detected and demodulated using for example demodulator 526 to recover downhole tool information.

The transmitter 520 and the detector 525 can be disposed at a surface region 504 of a wellbore 511 with the modulator 510 disposed at a tool 503 disposed downhole in the wellbore 511. The waveguide 505 can be disposed in a drill pipe 515. Alternatively, the waveguide 505 can be disposed on the outside of the drill pipe 515. The waveguide 505 can have a cross section structure to excite only TE₀₁ propagation to the modulator. Alternatively, the waveguide 505 can have a cross section structure to provide multi-mode propagation to the modulator.

The transmitter 520 may be realized by a number of different quasioptical wave generators/emitters. The quasioptical wave generators/emitter may include a free electron laser, a gas laser, aphotoconductive dipole antenna, an electro-optic material with a femtosecond laser, an electronic emitter such as Gunn, Bloch oscillator, cold plasma emitters, or semiconductor THz laser. The transmitter 520 may include an average power level in the range from 10⁻⁹ to 10² W. The transmitter 520 may be realized as a pair of distributed feedback lasers operating together to generate a beat note at a quasioptical frequency. The transmitter 520 can be selected based on a selected quasioptical frequency for propagation in waveguide 505. The transmitter 520 may be used with a modulator 512 to inject a quasioptical signal into waveguide 505. For example, a quasioptical wave modulator may be realized by modulating its excitation source at the surface 504 or by external deformable mirrors, choppers, electro-optic, or magneto-optic mechanism.

The detector 525 can be realized by a number of different quasioptical wave detectors/receivers. The quasioptical wave detectors/receiver can include a compact electronic detector, a photoconductive dipole and array, an electro-optic crystal with a femtosecond laser, a bolometer, or pyroelectric detector. The detector 525 may have a noise equivalent power (NEP) in the range 10⁻¹⁰ to 10⁻¹⁸ W/Hz^{1/2}. A quantum dot single photon detector having a NEP of about 10⁻²² W/Hz^{1/2} may be implemented.

The modulator 510 at the end of the waveguide 505 may be realized as a quasioptical wave modulator by modulating the quasioptical wave by deformable mirrors, choppers, electro-optic, or magneto-optic mechanisms. At the surface, the electromagnetic radiation from the transmitter 520 may also be modulated by the same modulation method as employed at the end of the waveguide 505. However, it is anticipated that a CW quasioptical wave can be generated at the surface 504, launched into the quasioptical waveguide 505 and transmitted downhole to the tool 503, whereby, the tool 503 contains the modulator 510 to impress tool information directly onto the CW quasioptical carrier wave. Quasioptical wave modulators suitable for high-speed telemetry and downhole communications can be used as taught herein.

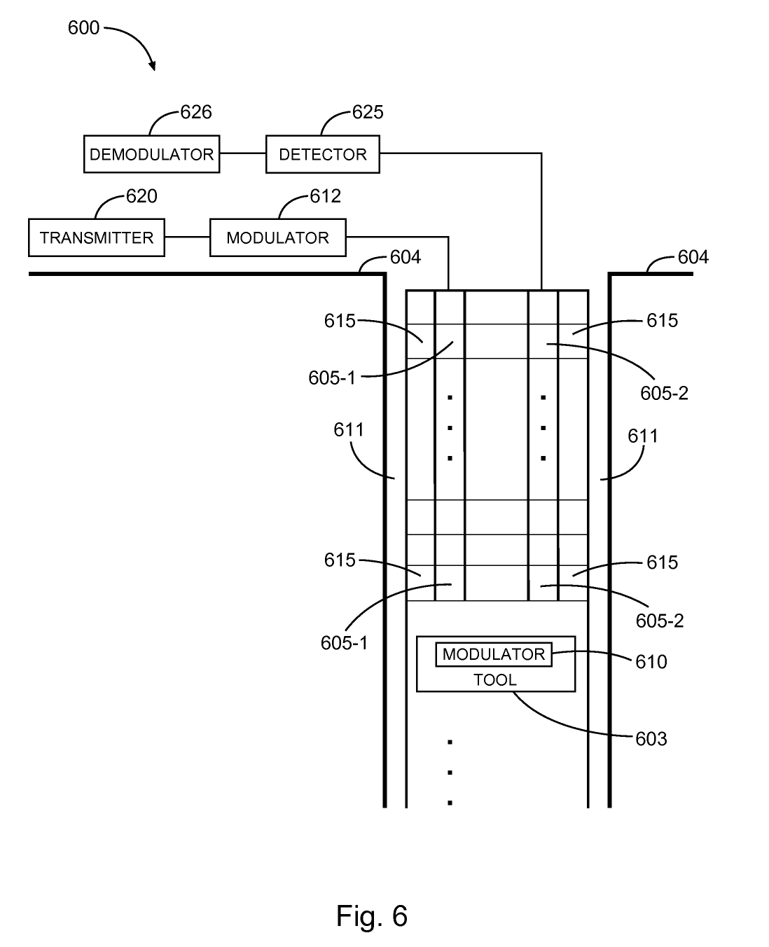

FIG. 6 shows an embodiment of an example system 600 operable to transmit and receive quasioptical signals in a wellbore 611. The system 600 can include a transmitter 620 operable to generate electromagnetic radiation in the frequency range from 30 GHz to 10 THz; a first waveguide 605-1 operatively coupled to the transmitter 620 to propagate the electromagnetic radiation generated from the transmitter 620; a modulator 610 disposed to receive the electromagnetic radiation from the first waveguide 605-1, to modulate the electromagnetic radiation received from the first waveguide 605-1, and to direct the modulated electromagnetic radiation back through a second waveguide 605-2; and a detector 625 operatively coupled to the second waveguide 605-2 to receive the modulated electromagnetic radiation. The waveguides 605-1, 605-2 can be structured as waveguide segments. This system architecture provides for a looped waveguide configuration (dual waveguide configuration) for transmission back to surface 604, where it can be detected and demodulated using for example demodulator 626 to recover downhole tool information.

The transmitter 620 and the detector 625 can be disposed at a surface region 604 of a wellbore 611 with the modulator 610 disposed at a tool 603 disposed downhole in the wellbore 611. The waveguide 605-1 can be disposed in a drill pipe 615. Alternatively, the waveguide 605-1 can be disposed on the outside of the drill pipe 615. The waveguide 605-2 can be disposed in the drill pipe 615. Alternatively, the waveguide 605-2 can be disposed on the outside of the drill pipe 615. The waveguides 605-1, 605-2 can have a cross section structure to excite only TE₀₁ propagation. Alternatively, the waveguide waveguides 605-1, 605-2 can have a cross section structure to provide multi-mode propagation.

The transmitter 620 may be realized by a number of different quasioptical wave generators/emitters. The quasioptical wave generators/emitter may include a free electron laser, a gas laser, a photoconductive dipole antenna, an electro-optic material with a femtosecond laser, an electronic emitter such as Gunn, Bloch oscillator, cold plasma emitter, or semiconductor THz laser. The transmitter 620 may include an average power level in the range from 10⁻⁹ to 10² W. The transmitter 620 may be realized as a pair of distributed feedback lasers operating together to generate a beat note at a quasioptical frequency. The transmitter 620 can be selected based on a selected quasioptical frequency for propagation in waveguide 605-1 and/or the combination of propagation in waveguides 605-1 and 605-2. The transmitter 620 may be used with a modulator 612 to inject a quasioptical signal into waveguide 605-1. For example, a quasioptical wave modulator may be realized by modulating its excitation source at the surface 604 or by external deformable mirrors, choppers, electro-optic, or magneto-optic mechanism.

The detector 625 can be realized by a number of different quasioptical wave detectors/receivers. The quasioptical wave detectors/receiver can include a compact electronic detector, a photoconductive dipole and array, an electro-optic crystal with a femtosecond laser, a bolometer, or pyroelectric detector. The detector 626 may have a noise equivalent power (NEP) in the range 10⁻¹⁰ to 10⁻¹⁸ W/Hz^{1/2}. A quantum dot single photon detector having a NEP of about 10⁻²² W/Hz^{1/2} may be implemented.

The modulator 610 at the end of the waveguide 605-1 may be realized as a quasioptical wave modulator by modulating the quasioptical wave by deformable mirrors, choppers, electro-optic, or magneto-optic mechanisms. At the surface, the electromagnetic radiation from the transmitter 620 may also be modulated by the same modulation method as employed at the end of the waveguide 605-1. However, it is anticipated that a CW quasioptical wave can be generated at the surface 604, launched into the quasioptical waveguide 605-1 and transmitted downhole to the tool 603, whereby, the tool 603 contains the modulator 610 to impress tool information directly onto the CW quasioptical carrier wave. Quasioptical wave modulators suitable for high-speed telemetry and downhole communications can be used as taught herein.

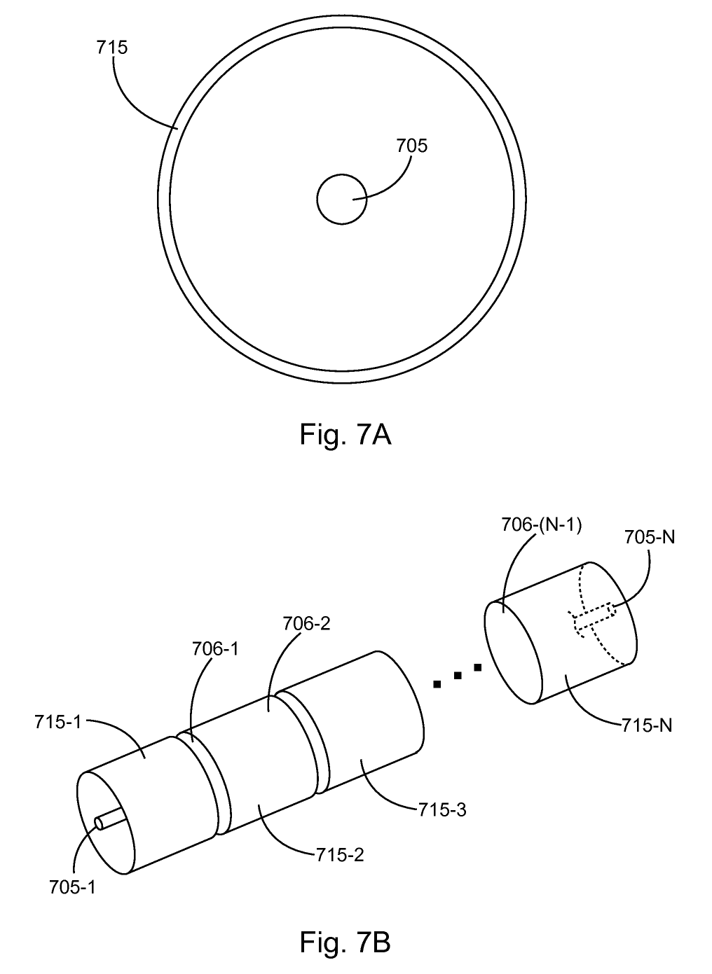

FIG. 7A shows cross-sections of an embodiment of an example a drill pipe 715 and a waveguide 705, where the waveguide 705 disposed within the drill pipe 715. The waveguide 715 can be realized as a conductive structure, as taught herein. The drill pipe 715 may be made of a material and have a geometric shape and length of a standard drill pipe used in the oil and gas industry. The use of such waveguides allows for connections that do not require the precision alignment associated with optical fibers. The waveguide 705 in drill pipe 715 arrangement can allow installation of the arrangement in a segmented control line style quasioptical wave transmission line within connected drill pipes during construction of a drill string via connection/disconnection with hydraulic wet connectors, as drill pipe is added or removed. It is noted that a waveguide such as waveguide 705 may be disposed in standard structures for terrestrial and aerial applications along pipelines and power lines.

FIG. 7B shows an embodiment of an example of a number of drill pipes 715-1, 715-2, 715-3 . . . 715-N connected together at each pipe joint, where each drill pipe has a waveguide disposed within it, such as represented in FIG. 7A. The combination of drill pipe 715-1 with its inner disposed waveguide 705-1 can be connected to the combination of drill pipe 715-2 and its inner disposed waveguide (not shown) by connector 706-1. The combination of drill pipe 715-2 and its inner disposed waveguide (not shown) can be connected to the combination of the combination of drill pipe 715-3 and its inner disposed waveguide (not shown) by connector 706-2. Each drill pipe/waveguide can be connected in such a manner up to connector 706-(N−1) connecting the combination of the last drill pipe 705-N and its inner diposed waveguide 705-N. The connected drill pipes 715-1, 715-2, 715-3 . . . 715-N provide for a quasioptical wave to be injected into and propagated in their associated waveguides. The connections may be hydraulic connections. Additional connectors can be used as a combination of drill pipe and inner disposed waveguide is added. Further, the connectors can be structured such that the combination of drill pipe and inner disposed waveguide can be removed.

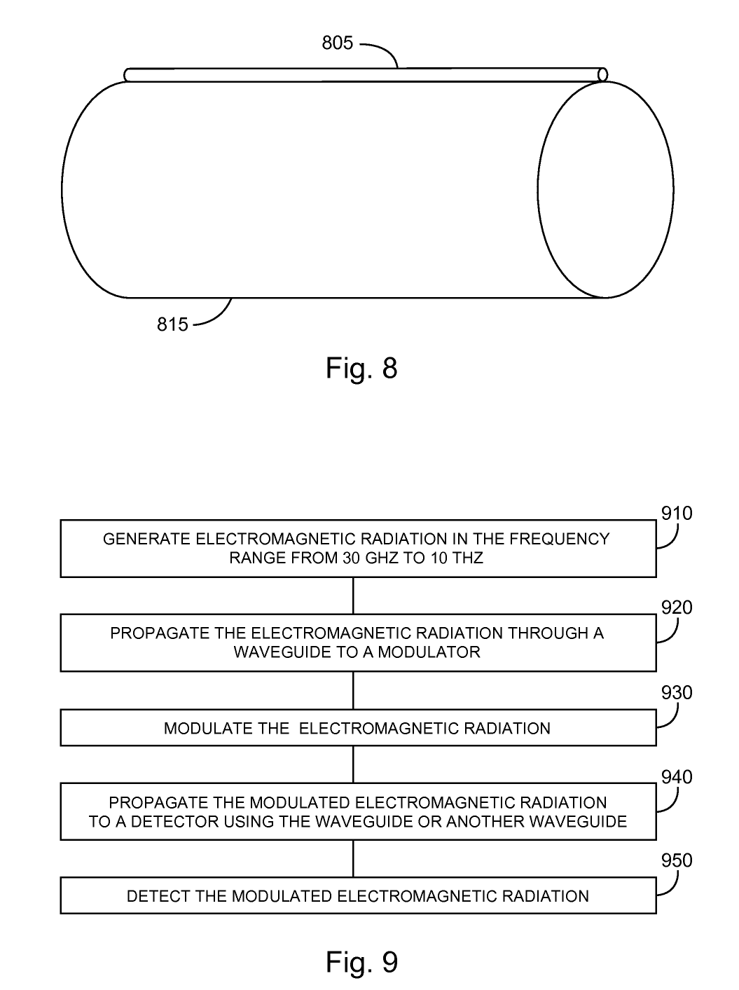

FIG. 8 shows an embodiment of an example drill pipe 815 having a waveguide 805 disposed outside the drill pipe 815. The waveguide 815 can be realized as a conductive structure, as taught herein. The drill pipe 815 may be made of a material and have a geometric shape and length of a standard drill pipe used in the oil and gas industry. The use of such waveguides allows for connections that do not require the precision alignment associated with optical fibers. The combination of the drill pipe 815 and the waveguide can be connected to other combinations of drill pipe and outside waveguide using connectors in a manner similar to FIG. 7B. The waveguide 805 on the outside of the drill pipe 815 arrangement can allow installation of the arrangement in a segmented control line style quasioptical wave transmission line in conjunction with connected drill pipes during construction of a drill string via connection/disconnection with hydraulic wet connectors, as drill pipe is added or removed. It is noted that a waveguide, such as waveguide 805, may be disposed on standard structures for terrestrial and aerial applications along pipelines and power lines.

FIG. 9 shows features of an embodiment of an example method of communicating using quasioptical waves. At 910, electromagnetic radiation in the frequency range from 30 GHz to 10 THz is generated from a transmitter. At 920, the electromagnetic radiation is propagated through a waveguide to a modulator. Propagating the electromagnetic radiation through the waveguide to the modulator can include propagating only a TE₀₁ mode. The method may include modulating the generated electromagnetic radiation before injecting the generated electromagnetic radiation into the waveguide. Modulating the generated electromagnetic radiation before injecting the generated electromagnetic radiation into the waveguide may include modulating the generated electromagnetic radiation using a deformable mirror.

At 930, the electromagnetic radiation is modulated by the modulator. Modulating the electromagnetic radiation can include modulating the electromagnetic radiation using a deformable mirror. Modulating the electromagnetic radiation can include inserting a data signal onto the electromagnetic radiation from a tool disposed downhole in a wellbore. At 940, the modulated electromagnetic radiation is propagated to a detector using the waveguide or another waveguide. At 950, the modulated electromagnetic radiation is detected at the detector. Generating electromagnetic radiation from the transmitter can include generating electromagnetic radiation from the transmitter disposed at a surface region of a wellbore; and propagating the modulated electromagnetic radiation to the detector can include propagating the modulated electromagnetic radiation to the detector disposed on the surface region of the wellbore. Methods disclosed herein can include combinations and/or permutations of different operational features disclosed herein.

Systems and methods, similar or identical to systems and methods discussed herein, can provide quasioptical electromagnetic waveguide telemetry links deployed within a wellbore while drilling to provide real-time high speed telemetry to and from the downhole drill bit control assembly, where conventional systems and methods to not exist to provide such functionality and capabilities. Embodiments of system and methods can be realized for either single-ended waveguide (reflective configuration) or looped (dual waveguide configuration) transmission back to the surface, where quasioptical waves modulated downhole in a wellbore can be detected and demodulated to recover downhole tool information. Embodiments of system and methods, as taught herein, can allow high speed (potentially mega-bit to gigabit) telemetry rates along standard drill pipes, outside or inside of the drill pipes, which can provide data while drilling. Such embodiments can allow installation of 30 ft to 40 ft standard drill pipe lengths having a segmented control line style quasioptical wave transmission line within the connected drill pipes during construction of a drill string via connection/disconnection with hydraulic wet connectors, as drill pipe is added or removed.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

What is claimed is:

1. A system comprising:
a transmitter operable to generate electromagnetic radiation in the frequency range from 30 GHz to 10 THz;
a waveguide operatively coupled to the transmitter to propagate the electromagnetic radiation generated from the transmitter;
a modulator disposed to receive the electromagnetic radiation from the waveguide, to modulate the electromagnetic radiation received from the waveguide, and to direct the modulated electromagnetic radiation back through the waveguide; and
a detector operatively coupled to the waveguide to receive the modulated electromagnetic radiation.

2. The system of claim 1, wherein the waveguide is structured as waveguide segments.

3. The system of claim 1, wherein the transmitter and the detector are disposed at a surface region of a wellbore and the modulator is disposed at a tool disposed downhole in the wellbore.

4. The system of claim 1, wherein the waveguide is disposed in a drill pipe.

5. The system of claim 1, wherein the waveguide is disposed on the outside of a drill pipe.

6. The system of claim 1, wherein the waveguide has a cross section structure to excite only TE₀₁ propagation to the modulator.

7. The system of claim 1, wherein the waveguide has a cross section structure to provide multi-mode propagation to the modulator.

8. A system comprising:
a transmitter operable to generate electromagnetic radiation in the frequency range from 30 GHz to 10 THz;
a first waveguide operatively coupled to the transmitter to propagate the electromagnetic radiation generated from the transmitter;
a modulator disposed to receive the electromagnetic radiation from the first waveguide and to modulate the electromagnetic radiation received from the first waveguide;
a second waveguide disposed to receive the electromagnetic radiation modulated by the modulator; and
a detector operatively coupled to the second waveguide to receive the electromagnetic radiation modulated by the modulator.

9. The system of claim 8, wherein the first and the second waveguides are structured as waveguide segments.

10. The system of claim 8, wherein the transmitter and the detector are disposed at a surface region of a wellbore and the modulator is disposed at a tool disposed downhole in the wellbore.

11. The system of claim 8, wherein the first waveguide and the second waveguide are disposed in a drill pipe.

12. The system of claim 8, wherein the first waveguide and the second waveguide are disposed on the outside of a drill pipe.

13. The system of claim 8, wherein the first waveguide and the second waveguide have a cross section structure to excite only TE₀₁ propagation to the modulator.

14. A method comprising:
generating electromagnetic radiation in the frequency range from 30 GHz to 10 THz from a transmitter;
propagating the electromagnetic radiation through a waveguide to a modulator;
modulating the electromagnetic radiation;
propagating the modulated electromagnetic radiation to a detector using the waveguide or another waveguide; and
detecting the modulated electromagnetic radiation at the detector.

15. The method of claim 14, wherein modulating the electromagnetic radiation includes modulating the electromagnetic radiation using a deformable mirror.

16. The method of claim 14, wherein propagating the electromagnetic radiation through the waveguide to the modulator includes propagating only a TE₀₁ mode.

17. The method of claim 14, wherein the method includes modulating the generated electromagnetic radiation before injecting the generated electromagnetic radiation into the waveguide.

18. The method of claim 17, wherein modulating the generated electromagnetic radiation before injecting the generated electromagnetic radiation into the waveguide includes modulating the generated electromagnetic radiation using a deformable mirror.

19. The method of claim 14, wherein modulating the electromagnetic radiation including inserting a data signal onto the electromagnetic radiation from a tool disposed downhole in a wellbore.

20. The method of claim 14, wherein generating electromagnetic radiation from the transmitter includes generating electromagnetic radiation from the transmitter disposed at a surface region of a wellbore; and propagating the modulated electromagnetic radiation to the detector includes propagating the modulated electromagnetic radiation to the detector disposed at a surface region of the wellbore.
